(19) United States
(12) Patent Application Publication
(10) Pub. No.: US 2020/0285005 A1
(43) Pub. Date: Sep. 10, 2020

(54) OPTICAL CONNECTION STRUCTURE

(71) Applicant: SUMITOMO ELECTRIC INDUSTRIES, LTD., Osaka-shi, Osaka (JP)

(72) Inventors: Takuro WATANABE, Yokohama-shi, Kanagawa (JP); Dai SASAKI, Yokohama-shi, Kanagawa (JP); Yoshikyo TAMEKUNI, Yokohama-shi, Kanagawa (JP)

(73) Assignee: SUMITOMO ELECTRIC INDUSTRIES, LTD., Osaka-shi, Osaka (JP)

(21) Appl. No.: 16/322,644

(22) PCT Filed: May 23, 2017
(86) PCT No.: PCT/JP2017/019256

§ 371 Date: Feb. 1, 2019

(30) Foreign Application Priority Data
Aug. 31, 2016 (JP) 2016-169166

(51) Int. Cl. G02B 6/42; G02B 6/38

(52) U.S. Cl. CPC G02B 6/4261; G02B 6/3825; G02B 6/3873; G02B 6/3893; G02B 6/3897; G02B 6/383

(57) ABSTRACT

A optical connection structure that includes a plurality of optical connectors and a housing is disclosed. In the optical connection structure, each optical connector includes a first and a second end surfaces. Each connector hole of the housing includes first and second inner wall surfaces facing each other. The first end surface includes a first guide rail. The second end surface includes a second guide rail or a latch. The first inner wall surface includes first guide rail fitting sections provided corresponding to the respective optical connectors, the first guide rail fitting sections being slidably fitted to the first guide rails. The second inner wall surface includes second guide rail fitting sections provided corresponding to the respective optical connectors and being slidably fitted to the second guide rails, or latch engagement sections provided corresponding to the respective optical connectors, the latches being engaged with the latch engagement sections.

### TECHNICAL FIELD

The present invention relates to an optical connection structure. The present application claims priority based on Japanese Patent Application No. 2016-169166 filed on Aug. 31, 2016, and the entire description thereof is incorporated herein by reference.

### BACKGROUND ART

Patent Literature 1 discloses a backplane connector that comprehensively connects a plurality of optical connectors using a backplane. In the backplane connector, a backplane housing attached to the backplane, and a printed board housing attached to a printed board provided for the backplane in a manner capable of advancing to and retracting from the backplane are each provided with a plurality of connector holes. The optical connectors are inserted into the respective connector holes. The printed board housing and the backplane housing are fitted to each other, thereby comprehensively connecting the optical connectors.

Patent Literature 2 discloses a backplane connector having a structure for accurately and comprehensively connecting optical connectors to each other by using the backplane. As to the backplane connector, latches for fixing optical connectors inside are provided on inner surfaces of connector holes of a backplane housing. The optical connectors are provided with respective latch engagement sections. When the optical connectors are inserted into backplane housing, the latches are engaged with the respective latch engagement sections, thereby fixing the optical connectors to the backplane housing.

### CITATION LIST

### Patent Literature

Patent Literature 1: Japanese Unexamined Patent Publication No. 2001-318274

Patent Literature 2: Japanese Unexamined Patent Publication No. 2001-154062

### SUMMARY OF INVENTION

An optical connection structure of this disclosure includes: a plurality of optical connectors arranged along a first direction; and a housing having a connector hole, the plurality of optical connectors being inserted into the connector hole along a second direction intersecting with the first direction, the connector hole comprehensively holding the optical connectors. Each optical connector includes a first end surface disposed on one side along a third direction intersecting with the first and second directions, and a second end surface disposed on another side along the third direction. The connector hole includes first and second inner wall surfaces facing each other in the third direction. The first end surface includes a first guide rail extending along the second direction. The second end surface includes a second guide rail extending along the second direction or a latch. The first inner wall surface includes a plurality of first guide rail fitting sections provided corresponding to the respective optical connectors, the first guide rail fitting sections being slidably fitted to the first guide rails along the second direction. The second inner wall surface includes a plurality of second guide rail fitting sections provided corresponding to the respective optical connectors and being slidably fitted to the second guide rails along the second direction, or a plurality of latch engagement sections provided corresponding to the respective optical connectors, the latches being engaged with the latch engagement sections.

### BRIEF DESCRIPTION OF DRAWINGS

FIG. 1 is a perspective view showing an appearance of a backplane connector as an optical connection structure according to one embodiment.

FIG. 2 is an enlarged partial view of the backplane connector shown in FIG. 1.

FIG. 3 is a perspective view of typifying and showing one of a plurality of plug connectors, and shows an appearance of the plug connector when being viewed from an obliquely downward side.

FIG. 4 is a perspective view showing a guide rail fitting section and therearound in an enlarged manner.

FIG. 5 is a perspective view showing a configuration of a backplane connector according to one variation example.

FIG. 6 is a perspective view showing an appearance of a plug connector according to one variation example.

FIG. 7 is a perspective view showing a guide rail fitting section and therearound in an enlarged manner.

FIG. 8 is a perspective view showing a configuration of a backplane connector according to another variation example.

FIG. 9 is a perspective view showing a configuration of a typical backplane connector.

FIG. 10 is an enlarged partial view of the backplane connector shown in FIG. 9.

### DESCRIPTION OF EMBODIMENTS

### Technical Problem Solved by Disclosure

A backplane connector is used to connect a plurality of optical connectors accommodated in a backplane housing, comprehensively to a back panel. It is desirable that at the backplane connector, the orientation of each optical connector be accurately held along a connection direction. For example, in a case where the plurality of optical connectors including MT ferrules are comprehensively connected to the back panel, the ferrules of the optical connectors on the backplane connector are required to be accurately positioned to ferrules of the optical connectors on the back panel by inserting guide pins into guide holes provided for the ferrules. However, in case the orientations of the optical connectors are not accurately held along the connection direction, the guide pins are not inserted into the guide holes and there is a possibility that the guide pints interfere with the ferrule end surfaces to damage the ferrule end surfaces.

As for the backplane connectors described in Patent Literatures 1 and 2, the optical connectors are isolated by the inner walls of the backplane housings. In this case, the dimensions of the backplane housing are increased by the thickness of the inner wall. Increase in the dimensions of the backplane housing obstructs ventilation to the back panel. Consequently, the back panel is not sufficiently heat-released, which may serve as causes of malfunctions.

### Advantageous Effects of Disclosure

According to this disclosure, reduction in size of the optical connection structure can be facilitated while the optical connectors are comprehensively connected in a state where the orientations are stabilized.

### DESCRIPTION OF EMBODIMENTS OF INVENTION OF THIS APPLICATION

First, the contents of embodiments of the present invention are listed and described. An optical connection structure according to one embodiment includes: a plurality of optical connectors arranged along a first direction; and a housing having a connector hole into which the respective optical connectors are inserted along a second direction intersecting with the first direction and which comprehensively holds the optical connectors. Each optical connector includes a first end surface disposed on one side along a third direction intersecting with the first and second directions, and a second end surface disposed on another side along the third direction. The connector hole includes first and second inner walls facing each other in the third direction. The first end surface includes a first guide rail extending along the second direction. The second end surface includes a second guide rail extending along the second direction or a latch. The first inner wall surfaces include a plurality of first guide rail fitting sections provided corresponding to the respective optical connectors, the first guide rail fitting sections being slidably fitted to the first guide rails along the second direction. The second inner wall surfaces include a plurality of second guide rail fitting sections provided corresponding to the respective optical connectors and being slidably fitted to the second guide rails along the second direction, or a plurality of latch engagement sections provided corresponding to the respective optical connectors, the latches being engaged with the latch engagement sections.

In the optical connection structure described above, the connector holes of the housing comprehensively hold the optical connectors. Accordingly, the optical connectors are held without being separated from each other by the inner walls. Consequently, the intervals between adjacent optical connectors can be reduced, and the width of the housing in the first direction can be reduced. That is, the housing can be reduced in size. In addition, when the optical connectors are inserted into the connector holes of the housing, the first guide rails provided for the respective optical connectors are slidably fitted to the first guide rail fitting sections provided on the first inner wall surfaces of the connector hole of the housing. The second guide rails (or latches) provided for the respective optical connectors are slidably fitted to the second guide rail fitting sections (or latch engagement sections) provided on the second inner wall surfaces of the connector hole of the housing. Accordingly, the orientations of the optical connectors are accurately held along the second direction (i.e., the connection direction). Consequently, according to the optical connection structure described above, the optical connectors can be comprehensively connected in a state where the orientations are stabilized.

In the optical connection structure described above, the first guide rail fitting section may be a groove denoted in the third direction, and include a flare section whose width in the first direction increases toward a first end in the second direction. In this case, the first guide rail may be inserted from the first end of the first guide rail fitting section. The first guide rail may be a projection projecting in the third direction, include a taper section whose width in the first direction decreases toward a second end in the second direction, and be inserted from the second end into the first guide rail fitting section. The narrower the gap in the first direction between the first guide rail and the first guide rail fitting section is, the more difficult the insertion of the first guide rail into the first guide rail fitting section becomes. Accordingly, as described above, the flare section or the taper section may be provided at an end of the first guide rail fitting section in the second direction, or an end of the first guide rail in the second direction. In this case, the first guide rail is guided by the taper section and is inserted into the first guide rail fitting section. Accordingly, the first guide rail can be easily inserted into the first guide rail fitting section. The gap in the first direction between the first guide rail and the first guide rail fitting section can be reduced, and the orientations of the optical connectors can be more accurately held.

In the optical connection structure described above, the first guide rail fitting section may be a projection projecting in the third direction, and the first guide rail may be a groove recessed in the third direction.

In the optical connection structure described above, the minimum value of the interval between the optical connectors may be 0.5 mm or less. According to the optical connection structure described above, the minimum value of the interval between the optical connectors can be such a significantly small value. Consequently, the width of the housing in the first direction can be further reduced. The housing can comprehensively hold the optical connectors in the connector hole while the adjacent optical connectors are not separated by the inner wall. Also in this case, the width of the housing in the first direction can be further reduced.

In the optical connection structure described above, the lengths of the first guide rail and the first guide rail fitting section in the second direction may be longer than half the length of a portion of the optical connector embedded in the connector hole in the second direction. Accordingly, the orientations of the optical connectors can be held sufficiently accurately. Meanwhile, the lengths of the first guide rails and the first guide rail fitting sections in the second direction may be shorter than the entire lengths of the optical connectors in the second direction.

In the optical connection structure described above, each of the optical connectors may include a latch, and a latch lever for releasing the engagement of the latch in the connector hole in the second end surface. Each of the optical connectors may include the latch, and the connector hole may include a latch engagement section to be engaged with the latch. As such structures are provided, the optical connectors can be connected to the housing by simple means for latch engagement, and the engagement can be easily released.

In the optical connection structure described above, the housing may further include other connector hole into which other optical connectors are inserted along the second direction and which comprehensively hold the other optical connectors. Inner wall may be provided between the connector hole and the other connector hole.

The inner wall may be provided at a center portion of the housing in the second direction. The connector hole and the other connector hole may have a symmetrical structure with respect to the inner wall. In this case, the optical connectors may include at least four optical connectors, for example.

### Details of Embodiments of Present Invention

Specific examples of the optical connection structure according to the embodiment of the present invention are hereinafter described with reference to the drawings. It is intended that the present invention is not limited to such examples, is represented by the scope of claims, and encompasses all modifications within the meanings equivalent to the scope of claims and the range of the scope of claims. According to the following description, in the description of the drawings, the same elements are assigned the same signs, and redundant description is omitted.

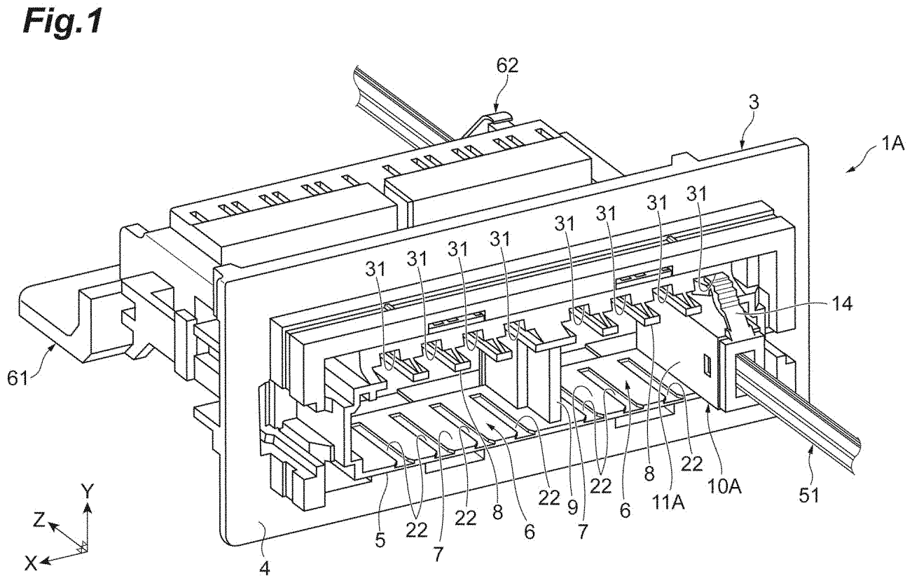

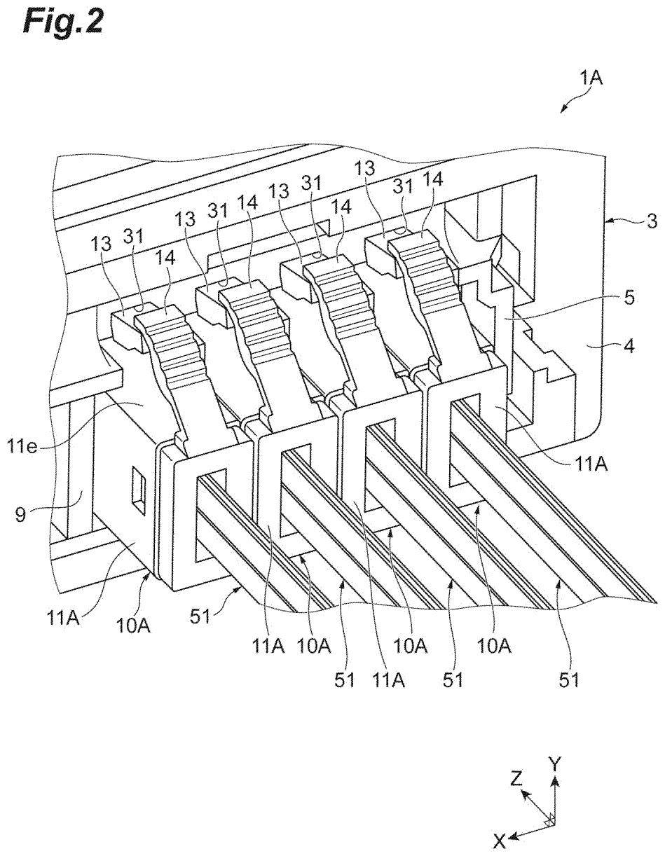

FIG. 1 is a perspective view showing an appearance of a backplane connector 1A as an optical connection structure according to one embodiment. FIG. 2 is an enlarged partial view of the backplane connector 1A shown in FIG. 1. For facilitating understanding, FIG. 1 shows only one plug connector 10A, and FIG. 2 shows a plurality of (four in this embodiment) plug connectors 10A. In each diagram, an XYZ orthogonal coordinate system is represented, as required. The X direction is the first direction in this embodiment. The Z direction is the second direction in this embodiment. The Y direction is the third direction in this embodiment. That is, the second direction is orthogonal to the first direction, and the third direction is orthogonal to the first and second directions. The orthogonality may be intersection. Consequently, the second direction may intersect with the first direction, and the third direction may intersect with the first and second directions.

The backplane connector 1A in this embodiment includes a plurality of plug connectors 10A (optical connectors) as shown in FIG. 2.

The plug connectors 10A are arranged along the X direction. Each plug connector 10A includes a plug housing 11A having a rectangular parallelepiped shape extending in the Z direction (front and rear direction). The plug housing 11A may be made of resin, for example. A tape fiber 51 extends from the rear end of the plug housing 11A.

The tape fiber 51 includes a plurality of optical fibers. The plug connector 10A is a multi-core optical connector that comprehensively connects these optical fibers. The backplane connector 1A integrally performs connection and separation of these plug connectors 10A to and from the corresponding optical connectors 62 embedded on the back panel 61.

The backplane connector 1A in this embodiment further includes a backplane housing 3 as shown in FIG. 1. The backplane housing 3 includes a planar-shaped external frame 4 extending in the XY plane, and connector accommodating sections 5 surrounded by the external frame 4. The connector accommodating section 5 is made of resin, for example, and has one or more (two in this embodiment) connector holes 6. In the example shown in FIG. 1, one inner wall 9 is provided at a center portion of the backplane housing 3 in the X direction between the two connector holes 6. The two connector holes 6 may have a line-symmetric structure with respect to the inner wall 9. The plug connectors 10A are inserted along the Z direction into each connector hole 6. That is, a plurality of (four in this embodiment) plug connectors 10A are inserted into each connector hole 6, while the inner wall that separates the plug connectors 10A is not provided at the gap between the plug connectors 10A adjacent to each other.

Consequently, each connector hole 6 comprehensively holds the plug connectors 10A. As the inner wall is not provided, the minimum value of the interval between the plug connectors 10A is a significantly small value, such as 0.5 mm or less, for example.

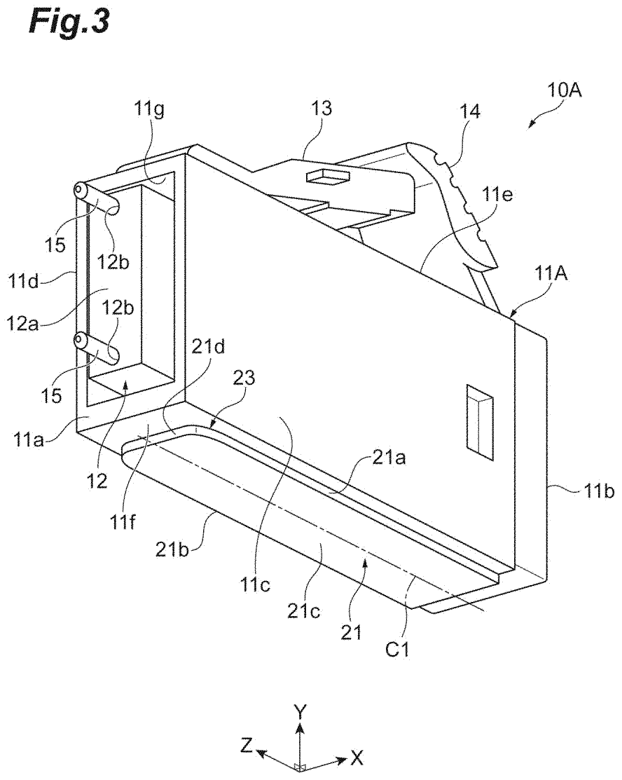

FIG. 3 is a perspective view typifying and showing one of the plug connectors 10A, and shows an appearance of the plug connector 10A when being viewed from an obliquely downward side. As shown in FIG. 3, the plug connector 10A includes a plug housing 11A, a ferrule 12, and guide pins 15. The plug housing 11A has a rectangular parallelepiped shape, as described above, and includes: a front end surface 11a and a rear end surface 11b that are opposite to each other in the Z direction; a pair of side surfaces 11c and 11d that are opposite to each other in the X direction; and an upper surface 11e and a lower surface 11f that are opposite to each other in the Y direction. The lower surface 11f is the first end surface in this embodiment, and the upper surface 11e is the second end surface in this embodiment. The pair of side surfaces 11c and 11d are formed substantially flat except a depression provided near to the rear end.

The front end surface 11a of the plug housing 11A includes an opening 11g for exposing the ferrule 12. The ferrule 12 projects from the opening 11g forward in the Z direction. The ferrule 12 in this embodiment is what is called an MT ferrule, and has a rectangular-parallelepiped appearance. One end surface thereof (front end surface) in the Z direction is a connection end surface 12a that faces the corresponding ferrule. From the connection end surface 12a, end surfaces of a plurality of optical fibers separated from the tape fiber 51 (see FIGS. 1 and 2) are exposed. These end surfaces are arranged one-dimensionally or two-dimensionally. On the connection end surface 12a, a pair of guide holes 12b for allowing the pair of guide pins 15 to be inserted therein is formed. These guide holes 12b are formed on the opposite sides in the Y-axis direction with the end surfaces of the optical fibers intervening therebetween. In FIG. 3, an example where the guide pins 15 are preliminarily inserted into the guide holes 12b is shown. Alternatively, the guide pins 15 may be preliminarily inserted into the guide holes of the ferrule of the corresponding optical connector (on the back panel 61).

The lower surface 11f of the plug housing 11A includes a guide rail (first guide rail) 21 extending in the Z direction. A guide rail 21 is formed to have a projection shape projecting in the Y direction. Specifically, the guide rail 21 includes a pair of side surfaces 21a and 21b intersecting with the lower surface 11f of the plug housing 11A, and a bottom surface 21c that connects the pair of side surfaces 21a and 21b. The pair of side surfaces 21a and 21b are formed perpendicular to the lower surface 11f, are parallel to each other, and extend in the Z direction. The bottom surface 21c is formed parallel to the lower surface 11f (that is, such that the normal direction is along the Y direction), and extends along the Z direction.

The guide rail 21 includes the taper section 23. The taper section 23 is provided at one end (second end) 21d of the guide rail 21 in the Z direction. At the taper section 23, the width of the guide rail 21 in the X direction gradually decreases toward the end 21d. At the taper section 23 in this embodiment, the opposite side surface s 21a and 21b of the guide rail 21 are surfaces curved with respect to the central axis line C1 of the guide rail 21. At the taper section 23, the opposite side surfaces 21a and 21b of the guide rail 21 may be flat surfaces inclined in directions opposite to each other with respect to the central axis line C1 of the guide rail 21. When the plug connector 10A is inserted into the backplane housing 3, the guide rail 21 is inserted (fitted) into a guide rail fitting section 22 from the end 21d.

The upper surface lie of the plug housing 11A includes a latch 13 and a latch lever 14. The latch 13 projects obliquely rearward from the upper surface lie of the plug housing 11A near to the front, and the distal end thereof is elastically displaced in the Y direction. As shown in FIGS. 1 and 2, the distal end of the latch 13 is engaged with a latch engagement section 31 of the backplane housing 3. Accordingly, the plug connector 10A is prevented from being detached from the backplane housing 3. The latch lever 14 projects obliquely frontward from the upper surface lie of the plug housing 11A near to the rear, and the distal end thereof covers the distal end of the latch 13. By an operator pressing the distal end of the latch lever 14 downward, engagement between the latch 13 and the latch engagement section 31 is cancelled.

FIG. 1 is referred to again. The connector hole 6 includes inner walls 7 and 8 facing each other in the Y direction. The inner wall surface 7 is the first inner wall surface in this embodiment, and the inner wall surface 8 is the second end surface in this embodiment. The inner wall surface 7 includes guide rail fitting sections 22 provided corresponding to the respective plug connectors 10A. Each guide rail fitting section 22 is slidably fitted along the Z direction to the guide rail 21 of the corresponding plug connector 10A. In other words, each guide rail fitting section 22 limits the movement of the corresponding plug connector 10A in the X direction, and allows the movement in the Z direction.

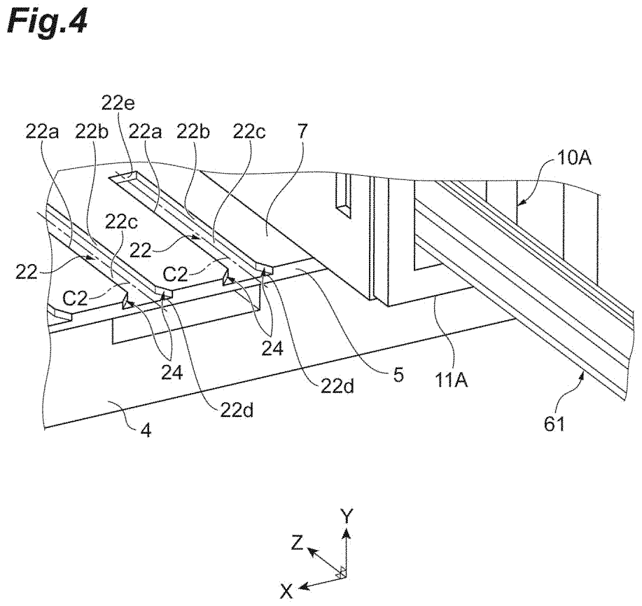

FIG. 4 is a perspective view showing the guide rail fitting section 22 and therearound in an enlarged manner. As shown in FIG. 4, the guide rail fitting section 22 is a groove recessed in the Y direction. Specifically, the guide rail fitting section 22 has a rectangular section perpendicular to the Z direction, and includes a pair of side surfaces 22a and 22b and a bottom surface 22c. The pair of side surfaces 22a and 22b are formed perpendicular to the inner wall surface 7, and extend in the Z direction. The bottom surface 22c is formed parallel to the inner wall surface 7 (that is, such that the normal direction is along the Y direction), and extends along the Z direction. When the guide rail 21 is inserted into the guide rail fitting section 22, the pair of side surfaces 21a and 21b of the guide rail 21 face the corresponding pair of side surfaces 22a and 22b of the guide rail fitting section 22, and the bottom surface 21c of the guide rail 21 faces the bottom surface 22c of the guide rail fitting section 22. In the state where the guide rail 21 is fitted to the guide rail fitting section 22, the plug housing 11A is moved frontward in the Z direction in the connector hole 6 of the backplane housing 3.

The guide rail fitting section 22 includes the flare section 24. The flare section 24 is provided at one end (first end) 22d of the guide rail fitting section 22 in the Z direction. At the flare section 24, the width of the guide rail fitting section 22 in the X direction gradually increases toward the end 22d. At the flare section 24 in this embodiment, the opposite side surfaces 22a and 22b of the guide rail fitting section 22 may be flat surfaces inclined in directions opposite to from each other with respect to the central axis line C2 of the guide rail fitting section 22. At the flare section 24, the opposite side surfaces 22a and 22b of the guide rail fitting section 22 may be surfaces curved in directions away from the central axis line C2 of the guide rail fitting section 22. When the plug connector 10A is inserted into the backplane housing 3, the guide rail 21 is inserted (fitted) from the end 22d of the guide rail fitting section 22.

In one embodiment, the end 21d of the guide rail 21 is positioned rearward than the front end surface 11a of the plug housing 11A. An end 22e of the guide rail fitting section 22 opposite to the end 22d is disposed rearward than the most inner part of the connector hole 6 (on a nearer side in FIG. 4). The Z-direction length of the guide rail 21 is shorter than the Z-direction length of the plug housing 11A. Meanwhile, the Z-direction length of the guide rail 21 is longer than half the Z-direction length of a portion of the optical connector 10A embedded in the connector hole 6. More preferably, this length is longer than ¾ of the Z-direction length of the embedded portion. Likewise, the Z-direction length of the guide rail fitting section 22 is longer than half the Z-direction length of the embedded portion of the optical connector 10A. More preferably, this length is longer than ¾ of the Z-direction length of the embedded portion. Meanwhile, the Z-direction length of the guide rail fitting section 22 is shorter than the Z-direction length of the plug housing 11A.

FIG. 1 is referred to again. The inner wall surface 8 of the connector hole 6 includes a plurality of latch engagement sections 31. The latch engagement sections 31 are provided corresponding to the respective plug connectors 10A, and are engaged with the latches 13 provided on the upper surface 11e of the plug housing 11A.

Specifically, each latch engagement section 31 has a shape, such as of a recessed groove being recessed in the Y direction with respect to the inner wall surface 8, and extends in the Z direction. When the plug connector 10A is inserted into the backplane housing 3, the latch 13 of each plug connector 10A is slidably fit to the corresponding latch engagement section 31 and is finally engaged with the latch engagement section 31. Each latch engagement section 31 limits the movement of the corresponding plug connector 10A in the X direction, and allows the movement in the Z direction.

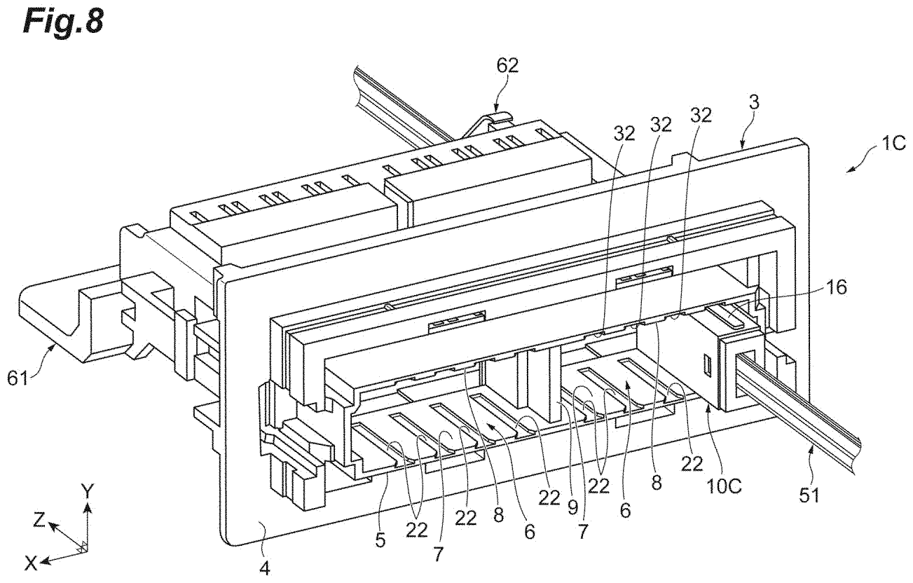

Note that the upper surface lie of the plug housing 11A may include a guide rail (second guide rail) 16 extending in the Z direction instead of the latch 13 (see FIG. 8). In this case, the inner wall surfaces 8 of the backplane connector 1C may include a plurality of guide rail fitting sections 32 instead of the plurality of the latch engagement sections 31; the guide rail fitting sections 32 are provided corresponding to the respective plug connectors 10C, and are slidably fitted to the guide rails 16 along the Z direction. The specific configurations of these guide rails 16 and guide rail fitting sections 32 are analogous to those of the guide rails 21 and guide rail fitting sections 22 described above.

Advantageous effects obtained by the backplane connector 1A according to this embodiment described above are described. As described above, the backplane connector 1A is used to connect the plurality of optical connectors 10A accommodated in the backplane housing 3, comprehensively to the back panel 61. It is desirable that at the backplane connector 1A, the orientation of each optical connector 10A be accurately held along the connection direction (Z direction). For example, in a case where the plurality of plug connectors 10A including the MT ferrules 12 are comprehensively connected to the back panel 61, the guide pins 15 are inserted into the guide holes 12b of the ferrules 12 (or the guide holes of the ferrules on the back panel 61), thereby accurately positioning the ferrules 12 of the plug connectors 10A on the backplane connector 1A and the ferrules of the plug connectors on the back panel 61 with respect to each other. However, in case the orientations of the plug connectors 10A are not accurately held along the connection direction, there is a possibility that the guide pins 15 are not inserted into the guide holes 12b of the ferrules 12 (or the guide holes of the ferrules on the back panel 61), and the guide pins 15 interfere with the connection end surfaces 12a of the ferrules 12 (or the ferrule end surfaces on the back panel 61) to damage the connection end surfaces 12a (or the ferrule end surfaces on the back panel 61).

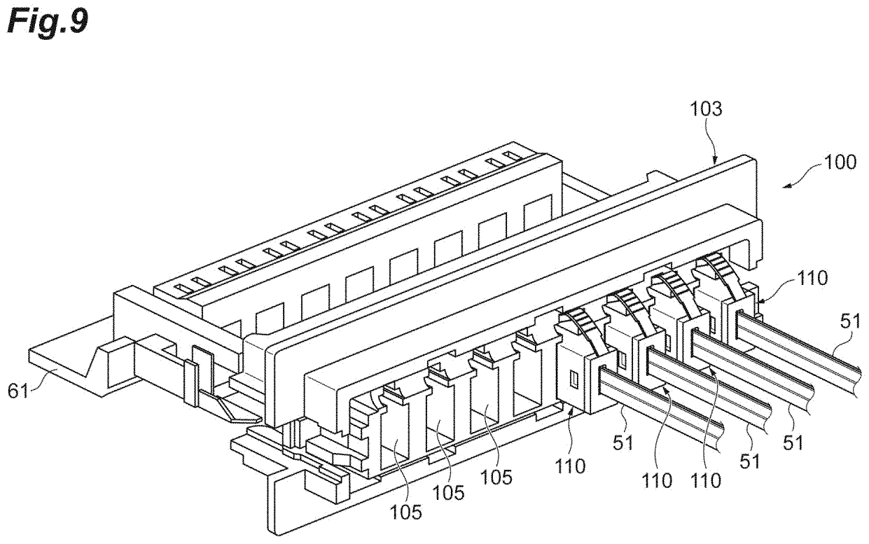

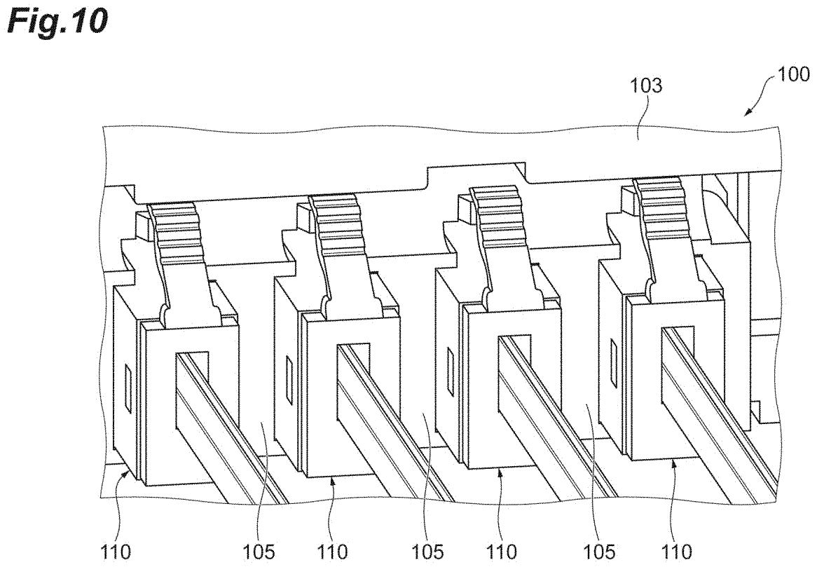

In a typical backplane connector, plug connectors are isolated by the inner walls of a backplane housing (for example, see Patent Literatures 1 and 2). FIG. 9 is a perspective view showing a configuration of such a backplane connector 100. FIG. 10 is an enlarged partial view of the backplane connector 100 shown in FIG. 9. In the backplane connector 100, plug connectors 110 are isolated by inner walls 105 of a backplane housing 103. In this case, the dimension of the backplane housing 103 in the X direction is increased by the thickness of the inner walls 105. Increase in the dimensions of the backplane housing 103 obstructs ventilation to the back panel 61. Consequently, the back panel 61 is not sufficiently heat-released, which may serve as causes of malfunctions.

According to the backplane connector 1A in this embodiment, the connector holes 6 of the backplane housing 3 comprehensively hold the plug connectors 10A. Accordingly, the plug connectors 10A are held without being separated from each other by the inner walls. Consequently, the intervals between adjacent plug connectors 10A can be reduced, and the width of the backplane housing 3 in the X direction can be reduced. That is, the backplane housing 3 can be reduced in size. When the plug connectors 10A are inserted into the connector holes 6, the guide rails 21 provided for the respective plug connectors 10A are slidably fitted to the guide rail fitting sections 22 provided on the inner wall surfaces 7 of the connector holes 6. The latches 13 (or guide rails) provided for the respective plug connectors 10A are slidably fitted to the latch engagement sections 31 (or guide rail fitting sections) provided on the inner wall surfaces 8 of the connector holes 6.

Accordingly, the orientations of the plug connectors 10A are accurately held along the Z direction (i.e., the connection direction).

Consequently, according to the backplane connector 1A in this embodiment, the plug connectors 10A can be comprehensively connected in a state where the orientations are stabilized. The advantageous effects obtained by the backplane connector 1C are analogous to the advantageous effects obtained by the backplane connector 1A that have been described above and are described below.

In the case where the guide rail fitting section 22 is a groove recessed in the Y direction as with this embodiment, the guide rail fitting section 22 may include the flare section 24 whose width increases in the X direction toward the end 22d in the Z direction. In the case where the guide rail 21 is the projection projecting in the Y direction, the guide rail 21 may include the taper section 23 whose width decreases in the X direction toward the end 21d in the Z direction.

The narrower the gap in the X direction between the guide rail 21 and the guide rail fitting section 22 is, the more difficult the insertion of the guide rail 21 into the guide rail fitting section 22 becomes. Accordingly, as described above, the taper and flare sections 23 and 24 may be provided at the one end 22d of the guide rail fitting section 22 in the Z direction and the one end 21d of the guide rail 21 in the Z direction. In this case, the guide rails 21 are guided by the taper and flare sections 23 and 24, and are inserted into the guide rail fitting sections 22. Accordingly, the guide rail 21 can be easily inserted into the guide rail fitting section 22. The gap in the X direction between the guide rail 21 and the guide rail fitting section 22 can be reduced, and the orientations of the plug connectors 10A can be more accurately held. In this embodiment, the guide rail 21 and the guide rail fitting section 22 include the taper and flare sections. Alternatively, only one of the guide rail 21 and the guide rail fitting section 22 may include the taper or flare section.

As with this embodiment, the minimum value of the interval between the plug connectors 10A may be 0.5 mm or less. According to the backplane connector 1A in this embodiment, the minimum value of the interval between the plug connectors 10A can be such a significantly small value. Consequently, the width of the backplane housing 3 in the X direction can be further reduced.

As described in this embodiment, the Z-direction lengths of the guide rail 21 and the guide rail fitting section 22 may be longer than half the Z-direction length of the part of the plug connector 10A inserted in the connector hole 6. Accordingly, the orientations of the plug connectors 10A can be held sufficiently accurately.

### Variation Example

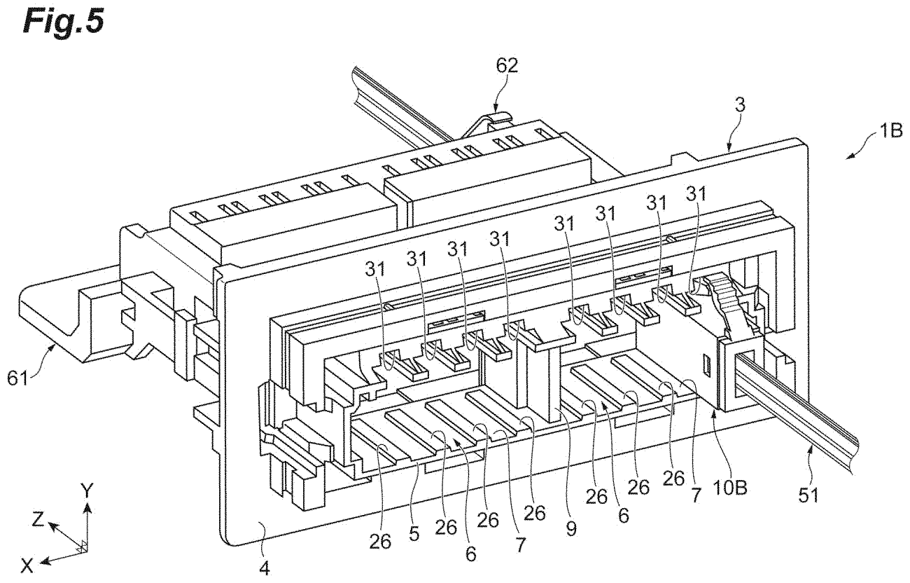

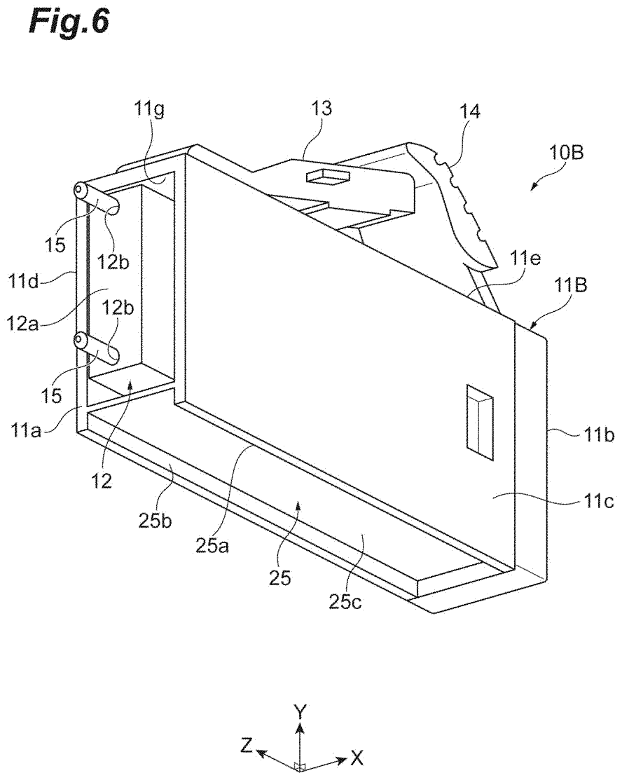

FIG. 5 is a perspective view showing a configuration of a backplane connector 1B according to one variation example of this embodiment described above. FIG. 6 is a perspective view showing an appearance of a plug connector 10B according to this variation example. The difference between this variation example and the embodiment described above is the shapes of the guide rails and the guide rail fitting sections. That is, the guide rails 21 in the embodiment described above are the projections protruding in the Y direction, while guide rails 25 in this variation example are grooves recessed in the Y direction. The guide rail fitting sections 22 in the embodiment described above are the grooves recessed in the Y direction, while guide rail fitting sections 26 in this variation example are projections protruding in the Y direction.

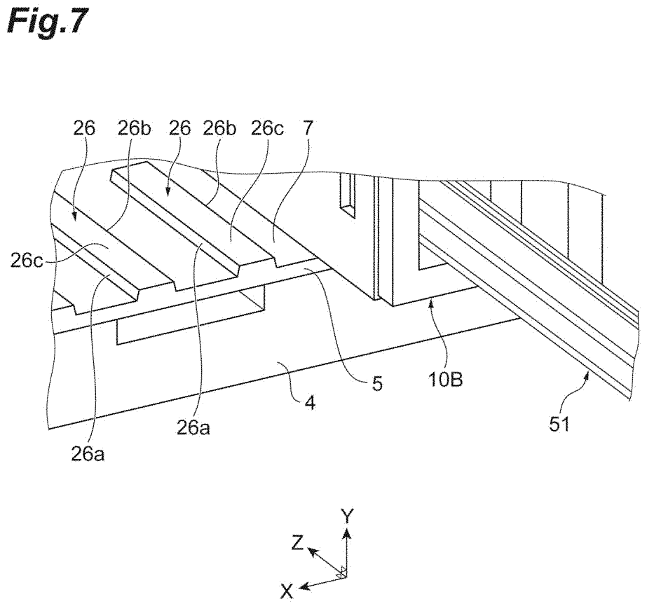

FIG. 7 is a perspective view showing the guide rail fitting section 26 and therearound in an enlarged manner. As shown in FIG. 7, the guide rail fitting sections 26 includes a pair of side surfaces 26a and 26b intersecting with the inner wall surface 7 of the connector hole 6, and a bottom surface 26c that connects the pair of side surfaces 26a and 26b. The pair of side surfaces 26a and 26b are formed perpendicular to the inner wall surface 7, and extend in the Z direction. The bottom surface 26c is formed parallel to the inner wall surface 7 (that is, such that the normal direction is along the Y direction), and extends along the Z direction.

As shown in FIG. 6, the guide rail 25 has a rectangular section perpendicular to the Z direction, and includes a pair of side surfaces 25a and 25b and a bottom surface 25c. When the guide rail 25 is inserted into the guide rail fitting section 26, the pair of side surfaces 26a and 26b of the guide rail fitting section 26 face the corresponding pair of side surfaces 25a and 25b of the guide rail 25, and the bottom surface 26c of the guide rail fitting section 26 faces the bottom surface 25c of the guide rail 25. In the state where the guide rail fitting section 26 is fitted to the guide rail 25, the plug housing 11B is moved frontward in the Z direction in the connector hole 6 of the backplane housing 3.

Also in the mode as in this variation example, the orientations of the plug connectors 10B are accurately held along the Z direction (i.e., the connection direction) in a manner analogous to that of the embodiment described above. Consequently, according to the backplane connector 1B in this variation example, the plug connectors 10B can be comprehensively connected in a state where the orientations are stabilized.

The optical connection structure according to the present invention is not limited to the embodiment described above. Other various modifications can be made. For example, the embodiment and variation example described above may be combined with each other in conformity with required objects and advantageous effects. In the embodiment described above, the configuration of the present invention is applied to the backplane connector. Alternatively, the configuration of the present invention may be applied to the connectors on the back panel. For example, at least one of the guide rail and the guide rail fitting section of the backplane connector according to the variation example may have a taper or flare section as in the embodiment described above. In the embodiment described above, the case where each optical connector is the multi-core optical connector has been exemplified. Alternatively, each optical connector may be a single-core optical connector.

### REFERENCE SIGNS LIST

1A, 1B, 1C . . . backplane connector, 3 . . . backplane housing, 4 . . . external frame, 5 . . . connector accommodating section, 6 . . . connector hole, 7, 8 . . . inner wall surface, 9 . . . inner wall, 10A, 10B . . . plug connector, 11A, 11B . . . plug housing, 11a . . . front end surface, 11b rear end surface, 11c, 11d . . . side surface, 11e . . . upper surface, 11f lower surface, 11g . . . opening, 12 . . . ferrule, 12a . . . connection end surface, 12b . . . guide hole, 13 . . . latch, 14 . . . latch lever, 15 . . . guide pin, 16, 21, 25 . . . guide rail, 21a, 21b, 25a, 25b . . . side surface, 21c, 25c . . . bottom surface, 21d . . . end, 22, 26, 32 . . . guide rail fitting section, 22a, 22b, 26a, 26b . . . side surface, 22c, 26c . . . bottom surface, 22d . . . end, 23, 24 . . . flare and taper sections, 31 . . . latch engagement section, 51 . . . tape fiber, 61 . . . back panel, 62 . . . optical connector, 100 . . . backplane connector, 103 . . . backplane housing, 105 . . . inner wall, 110 . . . plug connector, C1, C2 . . . central axis line.

1. An optical connection structure, comprising:
a plurality of optical connectors arranged along a first direction; and
a housing having a connector hole, the plurality of optical connectors being inserted into the connector hole along a second direction intersecting with the first direction, the connector hole comprehensively holding the optical connectors,
wherein each optical connector includes a first end surface disposed on one side along a third direction intersecting with the first and second directions, and a second end surface disposed on another side along the third direction,
the connector hole includes first and second inner wall surfaces facing each other in the third direction,
the first end surface includes a first guide rail extending along the second direction,
the second end surface includes a second guide rail extending along the second direction or a latch,
the first inner wall surface includes a plurality of first guide rail fitting sections provided corresponding to the respective optical connectors, the first guide rail fitting sections being slidably fitted to the first guide rails along the second direction, and
the second inner wall surface includes a plurality of second guide rail fitting sections provided corresponding to the respective optical connectors and being slidably fitted to the second guide rails along the second direction, or a plurality of latch engagement sections provided corresponding to the respective optical connectors, the latches being engaged with the latch engagement sections.

2. The optical connection structure according to claim 1,
wherein the first guide rail fitting section is a groove recessed in the third direction, and includes a flare section having a width increasing in the first direction toward a first end in the second direction, and
the first guide rail is inserted from the first end of the first guide rail fitting section.

3. The optical connection structure according to claim 1, wherein the first guide rail is a projection projecting in the third direction, includes a taper section having a width decreased in the first direction toward a second end in the second direction, and is inserted from the second end into the first guide rail fitting section.

4. The optical connection structure according to claim 1, wherein the first guide rail fitting section is a projection projecting in the third direction.

5. The optical connection structure according to claim 4, wherein the first guide rail is a groove recessed in the third direction.

6. The optical connection structure according to claim 1, wherein a minimum value of an interval between the optical connectors is 0.5 mm or less.

7. The optical connection structure according to claim 1, wherein lengths of the first guide rail and the first guide rail fitting section in the second direction are longer than half a length of a portion of the optical connector embedded in the connector hole in the second direction.

8. The optical connection structure according to claim 1, wherein lengths of the first guide rail and the first guide rail fitting section in the second direction are shorter than entire lengths of the optical connectors in the second direction.

9. The optical connection structure according to claim 1, wherein the housing comprehensively holds the optical connectors in the connector hole while the adjacent optical connectors are not separated by inner walls.

10. The optical connection structure according to claim 1, wherein each of the optical connectors includes the latch, and a latch lever for releasing engagement of the latch in the connector hole in the second end surface.

11. The optical connection structure according to claim 1, wherein each of the optical connectors includes the latch, and the connector hole includes a latch engagement section to be engaged with the latch.

12. The optical connection structure according to claim 1, wherein the optical connectors include at least four optical connectors.

13. The optical connection structure according to claim 1,
wherein the housing further includes another connector hole with other optical connectors being inserted therein in the second direction, the other connector hole comprehensively holding the other optical connectors, and
wherein an inner wall is provided between the connector hole and the other connector hole.

14. The optical connection structure according to claim 13, wherein the inner wall is provided at a center portion of the housing in the second direction.

15. The optical connection structure according to claim 13, wherein the connector hole and the other connector hole may have a symmetrical structure with respect to the inner wall.
